(19) United States
(12) Patent Application Publication
(10) Pub. No.: US 2026/0028134 A1
(43) Pub. Date: Jan. 29, 2026

(54) DATA INTELLIGENCE BASED AIRCRAFT PARAMETER ADJUSTMENT DURING A PARABOLIC MANUEVER

(71) Applicant: MU-G Technologies, LLC, Titusville, FL (US)

(72) Inventor: Robert WARD, Titusville, FL (US)

(21) Appl. No.: 19/276,237

(22) Filed: Jul. 22, 2025

Related U.S. Application Data
(60) Provisional application No. 63/674,665, filed on Jul. 23, 2024.

(51) Int. Cl. B64D 43/00; G01C 23/00

(52) U.S. Cl. CPC B64D 43/00; G01C 23/005

(57) ABSTRACT

Aspects of the present disclosure provide techniques for data intelligence based aircraft parameter adjustment in association with parabolic flight. Embodiments include receiving records of one or more completed flights, the records including temporal relationships among: velocity values; inputs that were provided to an aircraft control system; and pitch values. Embodiments include training a machine learning model based on the records to output an indication of a control system input to achieve a target pitch change when provided with velocity data and pitch data. Embodiments include using the machine learning model to determine an input to provide to a control system of an aircraft when a given velocity value and a given pitch value are detected. The control system of the aircraft may manipulate a control surface based on the input after detecting the given velocity value and the given pitch value during execution of a parabolic maneuver by the aircraft.

### RELATED APPLICATION

This application claims the benefit of U.S. Provisional Application Ser. No. 63/674,665 filed Jul. 23, 2024, and entitled DATA INTELLIGENCE BASED AIRCRAFT PARAMETER ADJUSTMENT DURING A PARABOLIC MANEUVER, the contents of which are hereby incorporated by reference in their entirety.

### INTRODUCTION

Aspects of the present disclosure relate to techniques for automatically determining aircraft parameter adjustments based on data intelligence while a parabolic maneuver is being executed.

### BACKGROUND

Parabolic flight generally involves simulating a zero-gravity experience in an aircraft through parabolic maneuvers. Such an experience may be useful for scientific research as well as for recreational purposes. For example, parabolic flight may give passengers the experience of weightlessness, reduced gravitational forces, and/or may simulate the gravitational forces experienced on celestial bodies other than Earth.

Existing parabolic flight techniques involve a pilot manipulating aircraft controls in order to achieve desired results. However, the inputs provided to aircraft controls do not always produce the desired results for a variety of reasons, particularly during parabolic maneuvers. For example, during times of rapid change in velocity, the effects of providing a particular input to an aircraft control such as moving a sidestick a particular amount may be different than the effects of providing the same input to the aircraft control under different conditions (e.g., when a parabolic maneuver is not being performed). Furthermore, in many types of aircraft, inputs to aircraft controls do not directly translate to predictable changes in aircraft control surfaces, such as due to mediation of flight control systems that consider other factors in addition to the inputs provided to the aircraft controls when determining how to move aircraft control surfaces. Thus, in many cases, parabolic maneuvers may not be performed in an optimal manner and/or for an optimal length of time due to such challenges.

Accordingly, there is a need in the art for improved techniques of achieving optimal aircraft control surface manipulations during a parabolic maneuver.

### BRIEF SUMMARY

Certain embodiments provide a method for data intelligence based aircraft parameter adjustment in association with parabolic flight. The method generally includes: receiving records of one or more completed flights, the records including temporal relationships among: velocity values; inputs that were provided to an aircraft control system; and pitch values; training a machine learning model based on the records to output an indication of a control system input to achieve a target pitch change when provided with velocity data and pitch data; and using the machine learning model to determine an input to provide to a control system of an aircraft when a given velocity value and a given pitch value are detected, wherein the control system of the aircraft manipulates a control surface based on the input after detecting the given velocity value and the given pitch value during execution of a parabolic maneuver by the aircraft.

Other embodiments comprise systems configured to perform the method set forth above as well as non-transitory computer-readable storage mediums comprising instructions for performing the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 is a diagram illustrating example components related to data intelligence based aircraft parameter adjustment in association with parabolic flight, according to certain embodiments.

FIG. 2 is a diagram illustrating example functionality of a data intelligence engine related to data intelligence based aircraft parameter adjustment in association with parabolic flight, according to certain embodiments.

FIG. 3 is a diagram illustrating example functionality of an aircraft computer system related to data intelligence based aircraft parameter adjustment in association with parabolic flight, according to certain embodiments.

FIG. 4 depicts example operations related to data intelligence based aircraft parameter adjustment in association with parabolic flight, according to certain embodiments.

FIG. 5 depicts example operations related to data intelligence based aircraft parameter adjustment in association with parabolic flight, according to certain embodiments.

FIGS. 6A and 6B depict example processing systems for data intelligence based aircraft parameter adjustment in association with parabolic flight, according to certain embodiments.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for data intelligence based aircraft parameter adjustment in association with parabolic flight.

Achieving optimal aircraft control surface manipulations for parabolic flight is a challenge, particularly due to the rapid changes in parameters (e.g., velocity) that occur during a parabolic maneuver. Furthermore, in many types of aircraft, inputs provided to an aircraft control (e.g., a sidestick or yoke) do not directly translate to predictable changes in aircraft control surfaces (e.g., an elevator), such as due to the intervention of a flight control system that considers a variety of factors, including control inputs, when determining how to manipulate control surfaces.

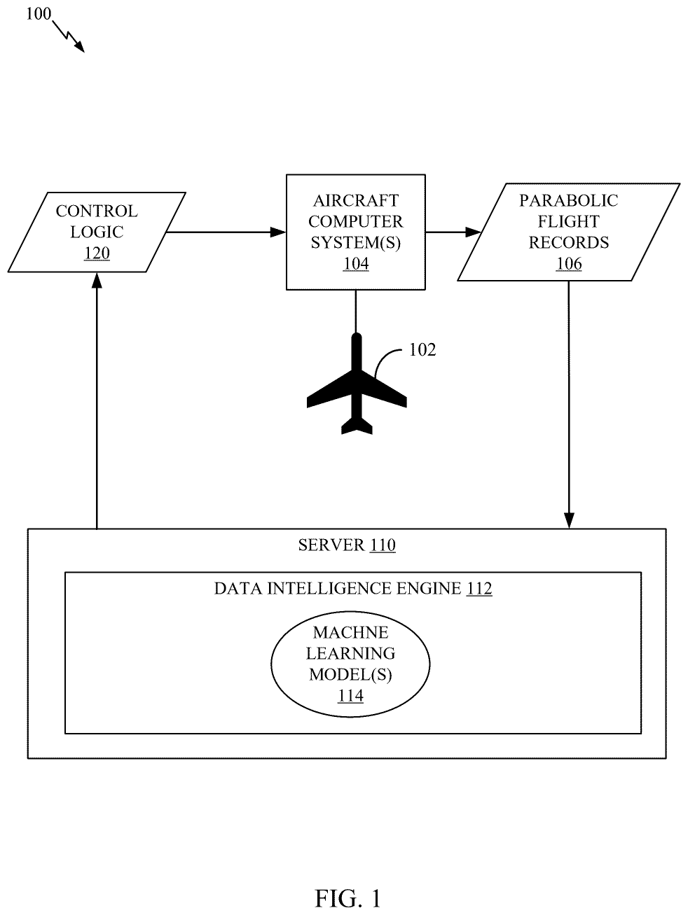

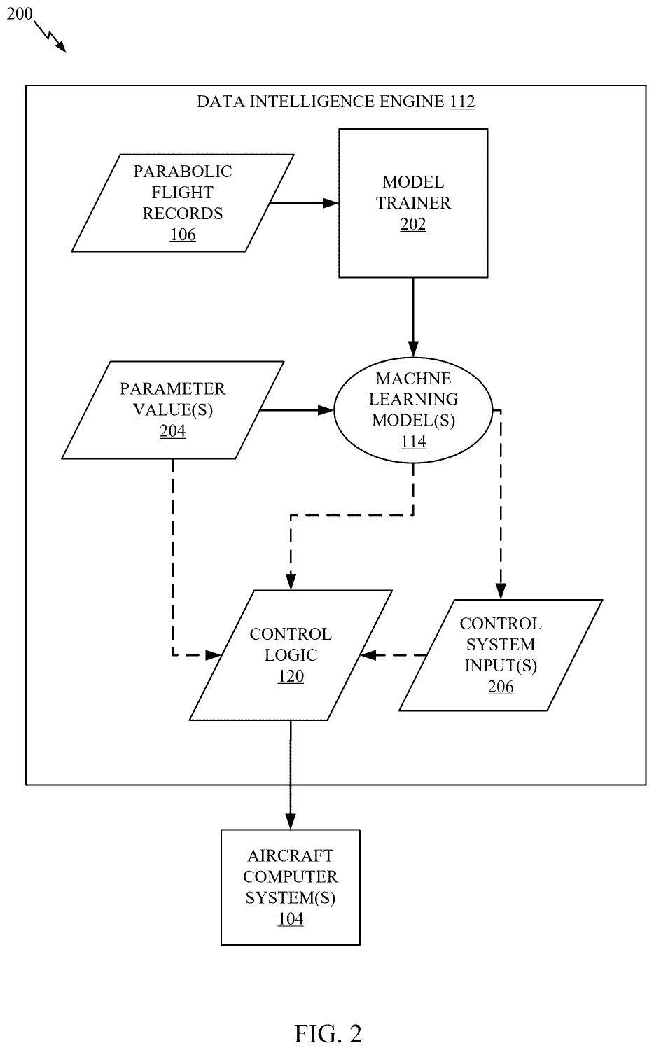

Techniques described herein overcome these challenges through a data intelligence based process for automatically determining parameter adjustments to perform during parabolic flight. As described in more detail below with respect to FIGS. 1 and 2, records captured during completed flights (e.g., in which parabolic maneuvers were performed) may be analyzed by a data intelligence engine in order to identify relationships between particular parameter values (e.g., including velocity, pitch, and/or the like) and particular control system inputs (e.g., that were provided by a pilot during the completed flights, such as via a sidestick, yoke, or the like). For example, one or more machine learning models may be trained based on such records, such as using supervised and/or unsupervised learning techniques, to output a control system input that should be provided in order to achieve a given result (e.g., change in pitch) under particular conditions (e.g., when particular parameter values, such as velocity and/or pitch values, are detected).

Once trained, a machine learning model may be used to determine inputs to provide to an aircraft control system (e.g., via one or more aircraft controls) under particular conditions. For example, the machine learning model may output an indication of a sidestick or yoke change that should be made when it is provided with a given velocity value and/or pitch value (and/or, in some embodiments, a target pitch value or delta pitch value) as input(s). In some embodiments, the machine learning model may be used “offline” to determine such values, such as on a computing device that is separate from the aircraft, and the determined values (e.g., correlations between particular parameter values and particular control system inputs) may be provided to a computing system on board the aircraft for use as control logic during flight (e.g., for recommending control system input and/or automatically providing control system inputs based on detected parameter values during a parabolic maneuver). In other embodiments, such as if permitted by regulatory authorities, the trained machine learning model may be run on a computing system on board the aircraft for use as control logic during flight.

Values described herein relating to pitch may refer to a variety of different values that relate to the pitch of the aircraft, such as pitch, flight path angle, angle of attack, and/or the like. For example, while pitch may sometimes refer to the angle between the horizon and the aircraft's longitudinal axis, flight path angle may refer to the angle between the horizon and the aircraft's flight path vector, and angle of attack may refer to the difference between the pitch and the flight path angle. Thus, aspects described herein with respect to pitch may also refer to other values related to pitch such as flight path angle and/or angle of attack. In a particular example, a model may be trained to determine inputs to provide to an aircraft control system to achieve a target change in flight path angle (e.g., which relates to a target change in pitch) given a particular set of determined aircraft parameter values (e.g., including a current flight path angle, which relates to a current pitch).

Control logic that is learned using techniques described herein may, in some embodiments, include mathematical and/or rules-based techniques instead of or in addition to supervised, unsupervised, or semi-supervised machine learning models. For example, a rules-based or mathematical technique may be learned based on analyzing historical data and determining mathematical and/or associative relationships between particular parameters and/or values.

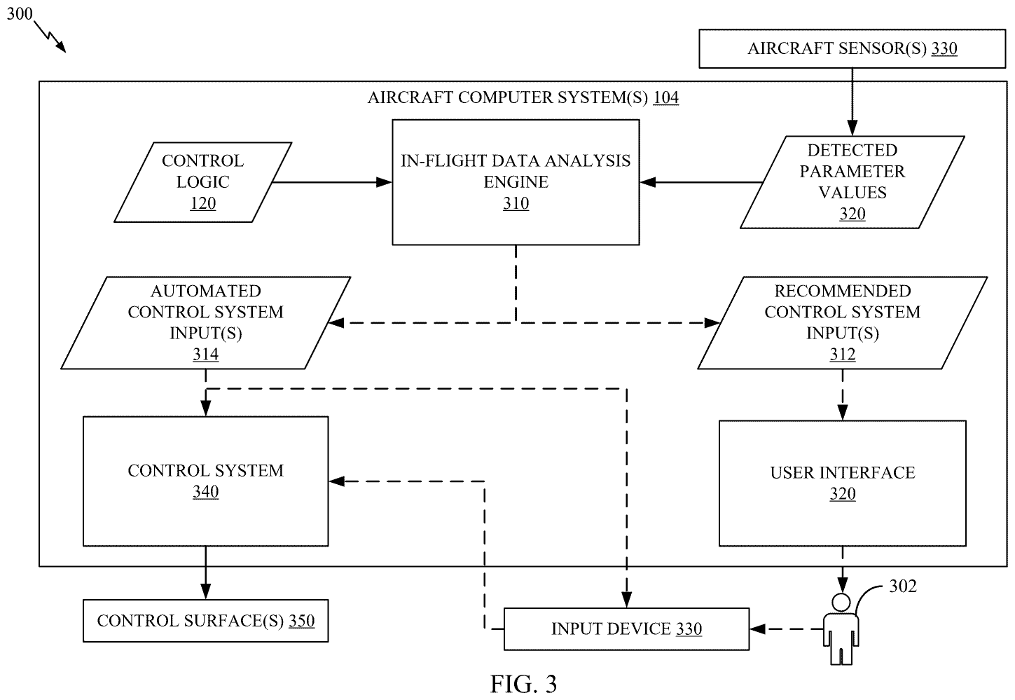

As described in more detail below with respect to FIG. 3, an in-flight data analysis engine may use control logic (e.g., determined using one or more machine learning models offline and/or that involves the use of one or more machine learning models online) to automatically determine control system inputs based on detected parameter values during a parabolic maneuver. The control system inputs determined by the in-flight data analysis engine may be used to display recommended control system inputs to a user via a user interface, such as providing a pilot with recommendations of inputs to provide to one or more controls, such as a sidestick or yoke, such as in real-time or near real-time based on detected parameter values. In other embodiments, the control system inputs determined by the in-flight data analysis engine may be used to automatically provide inputs to one or more controls, such as a sidestick or yoke, and/or to automatically provide inputs directly to a control system, such as in real-time or near real-time based on detected parameter values.

Techniques described herein improve the technical field of parabolic flight in a number of ways. For instance, by utilizing data intelligence (e.g., including one or more machine learning models) to automatically determine an optimal input to provide to an aircraft control system when particular parameter values (e.g., velocity and/or pitch values) are detected during a parabolic maneuver, such as to achieve a target result such as a change in pitch, techniques described allow predictable and optimal results to be obtained via control system inputs even during periods of rapid changes in parameters such as velocity and/or even in aircraft types in which control inputs do not directly translate to conventionally predictable changes in control surfaces (e.g., due to the intervention of a flight control system that considers a variety of factors, including control inputs, when determining how to manipulate control surfaces).

Furthermore, embodiments of the present disclosure allow a parabolic maneuver to be performed in such a manner as to achieve a lower level of gravitational force and/or for a longer period of time than would be achieved by conventional techniques. For example, by utilizing data intelligence (e.g., based on machine learning techniques as described herein) to automatically determine circumstantially appropriate control system inputs to provide to a control system as conditions change during a parabolic maneuver, embodiments of the present disclosure enable performance of a more optimized parabolic maneuver for an optimal amount of time. Performing automated analysis of records of completed flights in which parabolic maneuvers were performed in order to identify precise correlations between particular control system inputs (e.g., sidestick or yoke position) and particular parameters such as velocity and pitch allows such correlations to be used to automatically determine control system inputs to provide during subsequent flights in order to perform optimal parabolic maneuvers (e.g., while accounting for the variations in circumstances that affect parameter values and affect the relationships between control system inputs and control surface manipulations and/or resulting parameter changes).

Experimental results demonstrate that techniques described herein produce optimal parabolic maneuvers when control system inputs that are determined based on control logic described herein are input to an aircraft control system in a corresponding manner during execution of a parabolic maneuver. For example, testing shows that techniques described herein result in parabolic maneuvers that achieve microgravity for longer amounts of time than alternative techniques that do not involve data intelligence based parameter adjustment techniques as described herein.

### Example Computing Components Related to Data Intelligence Based Aircraft Parameter Adjustment

FIG. 1 is a diagram 100 illustrating example computing components related to data intelligence based aircraft parameter adjustment in association with parabolic flight, according to certain embodiments.

In diagram 100, an aircraft 102 comprises one or more aircraft computer systems 104. Aircraft 102 may, for example, include one or more control surfaces (e.g., including ailerons, an elevator, a rudder, and/or the like) that are controlled by a control system (e.g., running on one or more of aircraft computer system(s) 104), which receives inputs via one or more control devices (e.g., including a sidestick, yoke, or the like). A pilot may operate one or more controls of aircraft 102 in order to perform a parabolic maneuver, such by manipulating a sidestick or yoke. Records of parameters and inputs captured during flights in which parabolic maneuvers are performed may be stored on one or more of aircraft computer system(s) 104, and may be provided as parabolic flight records 106 to a separate computing device such as a server 110 for automated analysis. In some embodiments, parabolic flight records 106 may be provided to server 110 via an interface with the aircraft's ARINC-429 bus and/or another suitable data standard and/or interface, which may not be ARINC-429.

Server 110 generally represents a computing device, such as a server computer, that runs a data analysis engine 112, which performs certain operations described herein related to automatically determining control system inputs to provide under particular conditions. Server 110 may, for example, be located separately from aircraft 102, and may receive parabolic flight records 106 from aircraft computer system(s) 104 through a direct connection (e.g., cable, wireless, and/or the like) or indirectly (e.g., parabolic flight records 106 may be retrieved from aircraft computer system(s) 104 by one or more intermediate components and provided to server 110 via the one or more intermediate components). Data intelligence engine 112, in some embodiments, may train and/or use one or more machine learning models 114 based on parabolic flight records 106 for use in determining control system inputs that should be provided to a control system of aircraft 102 when particular parameter values are detected in order to achieve particular results. Training and use of machine learning model(s) 114 is described in more detail below with respect to FIG. 2.

Data intelligence engine 112 may determine control logic 120 based on parabolic flight records 106, and may provide control logic 120 to aircraft computer system(s) 104 (e.g., via a direct connection or through one or more intermediate components). Control logic 120 may, for example, include correlations between particular parameter values (e.g., velocity, pitch, and/or the like) and particular control system inputs that should be provided (e.g., via a sidestick or yoke, directly to the control system, and/or the like) when those particular parameter values are detected, such as to achieve a particular change in one or more parameters (e.g., pitch, gravity level, and/or the like). For example, control logic 120 may be generated based on identifying correlations in parabolic flight records 106 between particular parameter values that were detected, particular control system inputs that were provided (e.g., in connection with such detected parameter values), and resulting changes in one or more parameter values that were detected after the control system inputs were provided. For example, control logic 120 may include correlations determined using machine learning model(s) 114. In other embodiments, control logic 120 includes machine learning model(s) 114, such as if applicable regulatory authorities permit use of machine learning techniques during flight to determine control system inputs.

In some aspects, data intelligence engine 112 may learn aspects of control logic 120 based on analyzing parabolic flight records 106 in order to determine correlations, mathematical relationships, rules, and/or model parameters that can be used to determine particular control system inputs that should be provided (e.g., via a sidestick or yoke, directly to the control system, and/or the like) when particular parameter values are detected, such as to achieve a particular change in one or more parameters (e.g., pitch, gravity level, and/or the like). For example, control logic 120 may include logic for determining a target stick position (“StickY”) or other target control system input based on a flight path angle (or other angle or value relating to the pitch of an aircraft) and an air speed of the aircraft. In one example, StickY(t) (e.g., the target side stick position at time t) is computed based on dFPA/dt, TAS(t), and/or based on a target gravity level (e.g., G value) for time t or a target change in flight path angle for time t, where dFPA/dt is the first derivative of the flight path angle with respect to time and TAS(t) is the true airspeed at time t. TAS(t) may be received from the aircraft and dFPA/dt may be received from the aircraft or determined based on data received from the aircraft (e.g., flight path angle, angle of attack, pitch, altitude, air speed, and/or the like). In some aspects, the target gravity level for time t and/or the target change in flight path angle for time t may be determined based on how far the parabolic maneuver has progressed (e.g., where time t is in the time sequence of the parabolic maneuver). In some aspects flight path angle may be derived from pitch and/or angle of attack, either by the aircraft system, by control logic 120, and/or by data intelligence engine 112.

In some aspects, control logic 120 may involve modifying a sensitivity of the aircraft control system (e.g., side stick sensitivity) based on what point the aircraft is in a parabolic maneuver, and using the sensitivity of the aircraft control system as a factor when determining that target control system input (e.g., stick position). For instance, StickY(t) may be determined based on a flight path angle or other pitch-related value (and/or one or more additional parameters) associated with time t and based on a side stick sensitivity applicable to time t. The side stick sensitivity applicable to time t may be determined based on a time of flight counter that tracks how long a parabolic maneuver has been underway relative to the determined time of flight and/or otherwise based on where time t is relative to the start and/or target end of the parabolic maneuver.

In some aspects, the time of flight (e.g., the target time of flight) is determined based on the velocity and angle of attack or other pitch-related value of the aircraft (e.g., at the time the parabolic maneuver is initiated).

Aircraft computer system(s) 104 may utilize control logic 120 during flight. For example, as described in more detail below with respect to FIG. 3, aircraft computer system(s) 104 may receive detected parameter values from one or more sensors associated with aircraft 102, and may use control logic 120 to determine control system inputs that should be provided based on the detected parameter values. The automatically determined control system inputs may be displayed via a user interface associated with aircraft computer system(s) 104 as recommended control inputs (e.g., to be provided by a pilot via a control such as a sidestick or yoke), such as on an ongoing basis as new parameter values are detected and new control system inputs are automatically determined using control logic 120. In other embodiments (e.g., in an autopilot context, where permitted by regulatory authorities), the automatically determined control system inputs may be automatically provided to a control system associated with aircraft computer system(s) 104 (e.g., by automatically moving one or more controls such as a sidestick or yoke or by providing the control system inputs directly to the control system), such as on an ongoing basis as new parameter values are detected and new control system inputs are automatically determined using control logic 120.

Automatically determined control system inputs, whether recommended via a user interface and provided by a pilot via control inputs or automatically provided, may be received by the control system, which may manipulate one or more control surfaces of aircraft 102 based on the control system inputs. Thus, aircraft 102 may be controlled in an optimal manner to perform a parabolic maneuver that produces a lower gravity level and/or is performed for a longer amount of time than would have been achieved without automated control system input determination techniques described herein.

It is noted that while certain embodiments are described with respect to conventional aircrafts, techniques described herein may also be used with flight simulators, such as using flight records captured by such a simulator (e.g., as parabolic flight records 106) and/or using control system inputs determined using techniques described herein as inputs to a simulated control system of a flight simulator. While data from a simulator may generally be provided to systems described herein via a network connection such as via Ethernet, data from an actual aircraft may generally be provided to systems described herein via Aeronautical Radio, Incorporated (ARINC) 429 or a similar technique, possibly through a conversion box.

### Example Automated Determination of Control Logic for Parabolic Flight

FIG. 2 is a diagram 200 illustrating example functionality of a data intelligence engine related to data intelligence based aircraft parameter adjustment in association with parabolic flight, according to certain embodiments. Diagram 200 includes data intelligence engine 112, parabolic flight records 106, machine learning model(s) 114, control logic 120, and aircraft computer system(s) 104 of FIG. 1.

In diagram 200, data intelligence engine 112 includes a model trainer 202 that trains one or more machine learning models 114 based on parabolic flight records 106. For example, model trainer 102 may be a software component that utilizes supervised and/or unsupervised learning techniques to train machine learning model(s) 114.

Machine learning model(s) 114 may include one or more neural networks, tree-based models, Naïve Bayes classification models, regression models, clustering models, support vector machines, and/or the like.

A neural network (sometimes referred to as an artificial neural network or ANN) is generally modeled after a biological brain, and includes a plurality of interconnected nodes or “neurons”. Each node generally has one or more inputs that are associated with weights, a net input function, and an activation function. In a neural network, the nodes are typically included in a plurality of connected layers, where nodes of a given layer are connected to nodes of another layer, and various parameters govern the relationships between nodes and layers as well as other aspects of the operation of the neural network. A shallow neural network generally includes only a relatively small number of “hidden” layers between an input layer and an output layer while a deep learning model generally includes a relatively larger number of hidden layers. Examples of neural networks include an autoencoder network, deep neural network, deep belief network, recurrent neural network, convolutional neural network, perceptron, feed forward neural network, generative adversarial network (GAN), long short term memory (LSTM), sequence to sequence model, radial basis functional neural network, modular neural network, transformer model, and/or the like.

A tree-based model generally makes a classification by dividing inputs into smaller classifications at nodes, resulting in an ultimate classification at a leaf. Boosting, or gradient boosting, involves building a model of trees in a stage-wise fashion, optimizing a differentiable loss function. Boosting combines weak “learners” into a single strong learner in an iterative manner, where a weak learner generally refers to a classifier that selects a threshold for one feature and splits the data on the selected threshold. A weak learner is trained on that one feature, and generally is only loosely correlated with the true classification. A strong learner is a classifier that is arbitrarily well-correlated with the true classification, and that may be achieved through a process involving a combination of multiple weak learners to optimize an arbitrary differentiable loss function. Examples of boosted tree models include XGBoost and LightGBM. A random forest extends the concept of a tree-based model, involving a process in which the nodes included in any decision tree within the “forest” (of multiple trees) are selected with some amount of randomness, thereby reducing bias and grouping outcomes based on the most likely positive responses.

A Naïve Bayes classification model is based on the concept of dependent probability (e.g., the chance of one outcome given some other outcome), and allows for predictions of a class or category based on a given set of features, using probability.

A regression model, such as a logistic regression model, accepts inputs and calculates the probability of a particular outcome given the inputs, and a label may be applied based on whether the probability of the outcome exceeds a threshold.

Clustering models, such as k-means clustering models, generally find groups within the input data (e.g., with the number of groups represented by the variable k), and work iteratively to assign each data point to one of groups based on the features of the data points.

A support vector machine is a supervised learning model that analyzes data for classification and regression analysis, filtering data into categories based on a set of training examples that are marked as belonging to one of two categories. A support vector machine, once trained, assigns new values to one category or the other.

Model trainer 202 may use parabolic flight records 106 as training data for training a machine learning model 114 through supervised and/or unsupervised learning. For example, a training data set for a supervised learning process may include sets of parameter values (e.g., velocity and pitch values) associated with labels indicating control system inputs that were provided in temporal association with the sets of parameter values. In one example, a training data instance (e.g., in a training data set including a plurality of such instances) includes a set of parameter values (e.g., that were all associated with a particular timestamp or time window), a change in one or more parameter values that occurred following a control system input (e.g., within a particular time window following the control system input), and a label indicating the control system input (e.g., which may have been performed in temporal association with the set of parameter values). These data points may be automatically (and/or manually) extracted from parabolic flight records 106 (e.g., which may include timestamped parameter values and timestamped control system input values) in order to generate a training data set. In some cases, labels are manually applied and/or verified by a user.

Supervised learning generally involves providing training inputs (e.g., a set of one or more parameter values, a target value for one or more parameters such as pitch and/or gravity level, and/or the like) as inputs to a machine learning model 114, which the model processes to produce an output (e.g., indicating a control system input that should be provided to produce the target value for the one or more parameters given the input features). The output from the model may be compared to a ground truth label associated with the training inputs (e.g., the control system input that was actually provided in order to produce the target value for the one or more parameters after the set of one or more parameter values were detected, as indicated in parabolic flight records 106) and one or more parameters of the machine learning model 114 may be iteratively updated based on the comparing until one or more conditions are met. For instance, the one or more conditions may relate to an objective function (e.g., a cost function or loss function) for optimizing one or more variables (e.g., relating to model accuracy). In some embodiments, the conditions may relate to whether the outputs produced by the model based on the training inputs match the labels associated with the training inputs or whether a measure of error between training iterations is not decreasing or not decreasing more than a threshold amount. The conditions may also include whether a training iteration limit has been reached. In some cases, backpropagation is used during a supervised learning process. Parameters adjusted during training may include, for example, hyperparameters, values related to numbers of iterations, weights, functions used by nodes to calculate scores, and the like. In some embodiments, validation and testing are also performed for the machine learning model 114, such as based on validation data and test data, as is known in the art.

In another example, parabolic flight records 106 are used as training data for an unsupervised learning process, such as to build a machine learning model 114 that represents statistical correlations in parabolic flight records 106 and that can be used to determine a control system input that would produce a particular result (e.g., change in pitch, gravity level, and/or the like) under a particular set of circumstances (e.g., when particular attribute values are detected). Unsupervised learning involves learning patterns exclusively from unlabeled data, such as looking for similarities, differences, patterns, and structure in data by itself. During training, an unsupervised model attempts to mimic the data it is provided with and uses the error in its mimicked output to correct itself (e.g., correct its parameters such as weights and biases).

In some cases, a combination of supervised and unsupervised learning techniques are used to produce one or more machine learning models 114. Such an approach may be referred to as semi-supervised learning, which involves using both labeled and unlabeled data to train a model. In some embodiments, machine learning model(s) 114 include an ensemble of multiple machine learning models, such as of the same or different types.

The particular types of machine learning models and training methods described herein are included as examples, and other types of machine learning models and/or training algorithms may also be used with techniques described herein. For example, machine learning model(s) 114 may include other types of machine learning models such as a reinforcement learning model, principal component analysis model, Apriori model, graph-based model, linear or polynomial regression model, and/or the like.

Notably, parabolic flight records 106 do not necessarily represent optimal values (e.g., the control system inputs in parabolic flight records 106 may not have produced optimal results, such as optimal pitch changes and/or gravity levels), but are used to determine relationships between particular control system inputs and particular outcomes under particular circumstances, and this data intelligence can then be used to determine what an optimal control system input should have been to produce an optimal result under particular circumstances. For example, by training a machine learning model 114 based on parabolic flight records 106 to understand the effect that a particular control system input (e.g., change in sidestick or yoke position) typically has on one or more parameters (e.g., pitch, gravity level, and/or the like) under certain circumstances (e.g., when a particular velocity value is detected) for a particular aircraft (e.g., aircraft 102 of FIG. 1) or type of aircraft, techniques described herein enable such a machine learning model 114 to be used to determine the control system input that should be provided at each given point in time during a parabolic maneuver when a particular parameter value (e.g., velocity) or set of parameter values is detected in order to produce the optimal outcome (e.g., an optimal pitch value, gravity level, and/or the like, such as for the optimal amount of time). In particular, experimental results have demonstrated that inputs provided to a control such as a sidestick or yoke in temporal association with detected velocity values are significantly correlated with a predictable change in pitch and a resulting effect on gravity level.

It is noted that many other parameters may also be used in techniques described herein. For example, in addition to velocity, pitch, and/or gravity level, other parameters that may be used in training and using machine learning model(s) 114, such as in parabolic flight records 106 and/or parameter value(s) 204, include air speed, thrust, thrust lever position, jet engine core speed, aircraft pressure, cabin pressure, latitude and longitude, temperature(s), humidity, time since beginning parabolic maneuver, and/or the like.

In a particular example, a machine learning model 114 is trained based on analyzing parabolic flight records 106 in order to identify associations, correlations, rules, relationships, and/or the like between control system inputs, parameters such as pitch, flight path angle, angle of attack, velocity, air speed, latitude, longitude, gravity level and/or the like, and outcomes of the control system inputs, such as changes in pitch, flight path angle, angle of attack, gravity level, and/or the like. Such associations, correlations, rules, relationships, and/or the like (e.g., embodied in machine learning model 114) may then be used to determine a target control system input to achieve a desired outcome (e.g., in terms of change in gravity level, change in pitch or pitch-related value such as flight path angle or angle of attack) given a particular set of parameters (e.g., pitch, flight path angle, angle of attack, velocity, air speed, latitude, longitude, gravity level and/or the like).

While model trainer 202 is depicted as part of the same data intelligence engine 112 on which the trained machine learning model(s) 114 are used to produce outputs, other embodiments may involve machine learning model(s) 114 being trained on one or more separate devices from the one or more devices on which the trained machine learning model(s) are used to produce outputs.

Once trained, machine learning model(s) 114 may be used to determine control logic 120 that can be employed on aircraft computer system(s) 104 to determine control system inputs to provide to an aircraft control system to achieve particular results when particular attribute values are detected (e.g., during a parabolic flight). In one embodiment, machine learning model(s) 114 is/are provided to aircraft computer system(s) 104 (e.g., as part of control logic 120 or otherwise), such as if one or more regulatory authorities permit the use of machine learning models for in-flight determinations. In other embodiments, machine learning model(s) 114 is/are used “offline” (e.g., by data intelligence engine 112) to determine control system input(s) 206 based on particular parameter value(s) 204 in order to generate control logic 120 (e.g., control logic 120 may include associations between particular parameter values, particular target parameter values, and particular control system inputs that should be provided in order to achieve the particular target parameter values when the particular parameter values are detected).

For example, a machine learning model 114 may be used to determine a control system input 206 that should be provided to an aircraft control system in order to achieve a particular parameter value 204 after one or more other parameter values 204 have been detected. In one example, parameter value(s) 204 include a particular velocity value and a particular pitch or pitch-related value (and/or a particular gravity level) as well as a target pitch or pitch-related value (and/or a target gravity level), and are provided as inputs to a machine learning model 114, which outputs a control system input 206 in response to the inputs. Other examples are possible. In some cases, a machine learning model 114 is used to determine control system inputs 206 for a variety of different sets of parameter values 204 in order to generate control logic 120, so that control logic 120 includes associations or other types of logic that allow for accurate determinations of control system inputs to provide under a variety of different circumstances (e.g., sets of parameter values 204) in order to achieve optimal results (e.g., to maintain an optimal gravity level for an optimal amount of time during a parabolic maneuver). Thus, control logic 120 may contain significant amounts of data intelligence generated using machine learning model(s) 114 in such a manner that machine learning model(s) 114 do(es) not have to be used during flight. Rather, in such cases, control logic 120 may include deterministic logic/rules that can be applied during flight as parameter values are detected in order to determine control system inputs to recommend to a user/pilot and/or to automatically provide to a control system. A rule in control logic may, for example, indicate that when a particular one or more parameter values are detected, a particular control system input should be provided (e.g., via a sidestick or yoke) in order to achieve an optimal change in a particular one or more parameter values (e.g., lift, gravity level, pitch, pitch-related value, and/or the like).

Generally, control logic 120 may be generated by data intelligence engine 112 based on parabolic flight records 106 to indicate how the aircraft should be controlled to fly an optimal parabola, such as pushing and/or pulling a sidestick or yoke optimal amounts at optimal times (e.g., when particular parameter values are detected) such as to maintain a near-zero gravity level for as long as possible within safe limits. The optimal parabola may be determined based on a desired type of parabolic maneuver, such as zero-gravity, a particular low-gravity level (e.g., ⅙ gravity or moon gravity), and/or the like. Thus, control logic 120 may be configured so as to output the optimal control system input 206 for each time during a parabolic maneuver in order to maximize the time of flight for the particular level of microgravity that is desired.

A machine learning model 114 and/or control logic 120 may be generated in such a manner as to maximize vertical kinetic energy and/or a vertical velocity (e.g., referenced to Earth), such as outputting control system inputs that maximize an initial vertical velocity at the beginning of a microgravity portion of the parabolic maneuver.

As described in more detail below with respect to FIG. 3, aircraft computer system(s) 104 may use control logic 120 to automatically and dynamically determine control system inputs to recommend and/or automatically provide during performance of a parabolic maneuver.

### Example In-Flight Data Intelligence Based Control System Input Determination

FIG. 3 is a diagram 300 illustrating example functionality of an aircraft computer system related to data intelligence based aircraft parameter adjustment in association with parabolic flight, according to certain embodiments. Diagram 300 includes aircraft computer system(s) 104 and control logic 120 of FIGS. 1 and/or 2.

As described above with respect to FIG. 2, control logic 120 may include one or more machine learning models and/or one or more other types of logic (e.g., associations and/or rules) generated using one or more machine learning models. An in-flight data analysis engine 310 running on one or more of aircraft computer system(s) 104 utilizes control logic 120 to process detected parameter values 320 (e.g., received from one or more aircraft sensors 330) and determine control system inputs (e.g., in the form of automated control system input(s) 314 and/or recommended control system input(s) 312). Aircraft sensor(s) 330 may include one or more devices and/or components that detect values for parameters such as velocity, pitch, gravity level, air speed, thrust, thrust lever position, jet engine core speed, aircraft pressure, cabin pressure, latitude and longitude, temperature(s), humidity, time since beginning parabolic maneuver, and/or the like. For example, aircraft sensor(s) 330 may include speed sensor(s), pressure sensor(s), position sensor(s), gyroscope(s), resolver(s), humidity sensor(s), temperature sensor(s), accelerometer(s), magnetometer(s), software and/or hardware component(s) that monitor various aspects related to aircraft functions, and/or the like. Detected parameter values 320 may include, for example, velocity, lift, gravity level, air speed, thrust, thrust lever position, jet engine core speed, aircraft pressure, cabin pressure, latitude and longitude, temperature(s), humidity, time since beginning parabolic maneuver, and/or the like.

In-flight data analysis engine 310 may use control logic 120 to determine control system inputs that should be recommended or automatically provided based on detected parameter values 320. For example, in-flight data analysis engine 310 may first detect that a parabolic maneuver is being performed (e.g., based on one or more detected parameter values 320, such as a gravity level, a change in velocity and/or pitch, and/or the like) and/or based on input from a user (e.g., pilot 302). For example, in-flight data analysis engine 310 may determine that a parabolic maneuver has been entered when a gravity level is below a threshold (e.g., which may be configurable) for a given amount of time (e.g., which may be configurable).

When a parabolic maneuver is being performed, in-flight data analysis engine 310 may (e.g., iteratively, as each new set of values is detected) determine which control system input is indicated by control logic 120 for a given set of detected parameter values 320, such as to achieve a particular outcome (e.g., an optimal change in pitch, gravity level, and/or the like, which may be specified in control logic 120). Target or optimal outcomes or values may be determined, for example, based on an ideal trajectory for the parabolic maneuver (e.g., which may be based on learned, configured, and/or detected values), which may be continuously updated as new parameter values are detected. If control logic 120 includes one or more machine learning models, one or more detected parameter values 320 may be provided as input(s) to a machine learning model (e.g., in conjunction with a target value for one or more parameters such as pitch or gravity level, which may be indicated in control logic 120 and/or otherwise known by in-flight data analysis engine 310 based on configuration), and the one or more machine learning models may output a control system input in response to the one or more inputs. If control logic 120 does not include a machine learning model, one or more associations, rules, and/or the like in control logic 120 may be used to determine the control system input that should be provided based on detected parameter values 320 to achieve the optimal result (e.g., a target value for one or more parameters such as pitch or gravity level, which may be indicated in control logic 120 and/or otherwise known by in-flight data analysis engine 310 based on configuration). In one example, control logic 120 includes associations between parameter values (e.g., for one or more parameters such as velocity, pitch, and/or the like), target values for one or more parameters (e.g., pitch, gravity level, and/or the like), and control system inputs.

In one embodiment, such as when control logic 120 is used by an autopilot system (e.g., as permitted by regulatory authorities), automated control system input(s) 314 (determined by in-flight data analysis engine 310 based on control logic 120 and detected parameter values 320) are provided either directly to control system 340 or via automated manipulation of an input device 330 that provides input to control system 340. Control system 340 may, for example, represent an aircraft flight control system that manipulates one or more control surfaces 350 (e.g., via electrical signals and/or mechanical control), such as based on a variety of factors including inputs from input device 330. Input device 330 may represent a control such as a sidestick or yoke. Control surface(s) 350 may include, for example, an elevator, ailerons, a rudder, and/or the like. In some embodiments, control system 340 considers factors other than inputs from input device 330 when determining how to manipulate a corresponding control surface 340 (e.g., input device 330 may get a “vote” while other factors may also be involved in the final determination). Techniques described herein address this challenge through data intelligence that is used to determine control system inputs that should be provided to produce target outcomes under particular circumstances based on how control system 340 has been observed to operate over time (e.g., via flight records, as described above).

In another embodiment, recommended control system input(s) 312 (determined by in-flight data analysis engine 310 based on control logic 120 and detected parameter values 320) are provided to a user interface 320 for display via a display device. For example, a pilot 302 may view the user interface 320 via a display device and may provide inputs to input device 330 according to the displayed recommended control system input(s) 312. For example, user interface 320 may be updated on an ongoing basis with the latest recommended control system input 312 based on the most recently detected parameter values 320 so that the pilot 302 is enabled to provide the recommended control system inputs to control system 340 via input device 330 throughout the parabolic maneuver. For example, user interface 320 may be used to continuously provide the pilot 302 with aircraft attitude symbology (e.g., waterline or ownship), a guidance (fly to) diamond, airspeed, airspeed trend, and preparatory guidance such as flashing arrows indicating imminent recommended input device changes (e.g., representing recommended control system input(s) 312, such as indicating push/pull for a sidestick), flashing/boxing/colorizing of airspeed and airspeed trend to indicate imminent power (throttle) changes, and/or the like. The system may also be capable of providing auditory cues (e.g., to provide recommended control system input(s) 312 to pilot 302), which may be operator configurable, if authorized by regulatory authorities.

Additional cues provided may include a prompt to relax input device 330 pull force as the aircraft approaches high pitch angles and stall speed, and a visual representation of where in a maneuver and overall profile of all planned maneuvers the aircraft is currently operating based on the system's own guidance solution (this may be implemented as a side scroll representation of an index mark, sine-like waves, and numerical count). The pilot 302 may follow the guidance provided by user interface 320 until the parabolic maneuver is completed.

An example of displaying recommended control system inputs such as target sidestick deflections is described in U.S. patent application Ser. No. 18/491,952, filed on Oct. 23, 2023 and titled “SYSTEM AND METHOD FOR PROVIDING FLIGHT GUIDANCE DURING A PARABOLIC MANEUVER,” the contents of which are incorporated herein by reference in their entirety for all purposes.

In some embodiments, input device 330 is configured with a device control apparatus, such as including an “aft stop” and a “forward stop” to help minimize the adverse effects of the force feedback on input device 330 during a reduced-gravity maneuver (e.g., parabolic maneuver). Additionally, the aft and forward stops may be controlled using data from the aircraft to help position the stops to the ideal positions based on the programmed reduced-gravity maneuver and actual conditions. While the input device 330 (e.g., sidestick) is in contact with either the aft or forward stop, the guidance computer (e.g., in-flight data analysis engine 310 or other computing component) may “nudge” the input device 330 to help the pilot 302 maintain the ideal input device position for the reduced-gravity maneuver. A “nudge” may be executed by activating a control motor to move input device 330 in a desired direction. For example, automated control system input(s) 314 may be provided to control system 340 by way of nudging input device 330 by activating a control motor to move input device 330 particular amount(s) in particular direction(s). In some cases, a combination of automated control system input(s) 314 and recommended control system input(s) 312 is used, such as using automated nudges to assist the pilot 302 with providing recommended control system inputs via input device 330.

In one example, the pilot 302 sets the desired g-level (e.g., gravity level) for an upcoming reduced-gravity maneuver. The pilot 302 may then maneuver the aircraft to the desired altitude or airspeed prior to moving the sidestick (e.g., input device 330) aft to the desired position for the entry into the reduced gravity maneuver. As the pilot is moving the sidestick to the aft stop, the current rate of sidestick position change may be displayed on a display (e.g., located on the glareshield), such as via user interface 320, along with the desired or target rate of sidestick position change (e.g., recommended control system input(s) 312). Simultaneously displaying the actual and desired rates of change may help the pilot 302 smoothly enter the reduced-gravity maneuver until the sidestick contacts the aft stop. While the aircraft climbs to the desired position to begin the reduced-gravity portion of the maneuver, the aft stop may receive input from aircraft computer system(s) 104 (e.g., in the form of automated control system input(s) 314) and “nudge” the sidestick to help maintain the energy of the aircraft and reduce the possibility of either stalling the aircraft or entering Mach buffet onset.

User interface 320 may provide an indication to the pilot 302 that the aircraft has reached the optimum position to begin the reduced-gravity portion of the maneuver, and may prompt the pilot 302 to begin moving the sidestick from the aft position forward. As the pilot is moving the sidestick to the forward stop, the current rate of sidestick position change may be displayed on a display (e.g., located on the glareshield), such as via user interface 320, along with the desired or target rate of sidestick position change to help the pilot smoothly enter the reduced gravity portion of the maneuver until the sidestick contacts the forward stop. While the sidestick is in contact with the forward stop during the reduced gravity portion of the maneuver, the forward stop may receive input from aircraft computer system(s) 104 (e.g., in the form of automated control system input(s) 314) to help “nudge” the sidestick and assist the pilot with maintaining the desired reduced-gravity level.

Once the aircraft has completed the reduced-gravity portion of the parabolic maneuver, user interface 320 may prompt the pilots 302 to begin the exit portion of the maneuver. As the pilot 302 is moving the sidestick to the aft stop, the current rate of sidestick position change may be displayed on a display (e.g., located on the glareshield), such as via user interface 320, along with the desired rate of sidestick position change to help the pilot smoothly enter the reduced-gravity maneuver until the sidestick contacts the aft stop. While exiting the parabolic maneuver, the aft stop may receive input from aircraft computer system(s) 104 (e.g., in the form of automated control system input(s) 314) to help “nudge” the sidestick to help maintain the energy of the aircraft and reduce the possibility of either stalling the aircraft or entering Mach buffet onset.

The overall design of such a device control apparatus may allow for the pilot 302 to maintain the ability to manually fly the aircraft and override the device control apparatus if required either through pressing an autopilot disconnect on the sidestick and thus commanding the forward and aft stops to move out of the way quickly and deenergize their control motors or through a mechanical disconnect that will allow for the forward and aft stops to be positioned clear of any interaction with the sidestick. Such a device control apparatus is described in U.S. Provisional Patent Application 63/581,773, filed on Sep. 11, 2023 and titled “SIDESTICK CONTROL APPARATUS,” the contents of which are incorporated herein by reference in their entirety for all purposes.

In some aspects, techniques described herein (e.g., for determining target control system inputs using control logic and outputting such target control system inputs, such as via a user interface) are initiated once the pilot has initiated maneuvers that are associated with beginning a steep climb (e.g., based on parameters received from the aircraft and/or based on control system inputs provided by the pilot), such as transitioning the system to a parabola ready state and beginning to calculate aircraft dynamics. From those aircraft dynamics, the system may provide the target control system inputs to maximize the climb as described herein.

For example, states may include initialization (e.g., after boot, initializing data structure, acquiring data), cruise (e.g., normal flight and recovery after parabola end), parabola ready (e.g., entrance to parabola initiated), parabola start warning (e.g., approximately one second before parabolic flight commences), parabola start (e.g., beginning of parabola with a gravity level of approximately zero), parabola end warning (e.g., approximately one second before end of parabola), and parabola end (e.g., end of parabolic flight, beginning pull-up). During the parabola start warning state, the target control system inputs may begin to be displayed via the user interface 320. Such data may be determined and displayed on an ongoing basis throughout the states of the parabola, such as until the parabola end state is detected.

It is noted that techniques described herein may be implemented with or without such a device control apparatus (e.g., including an aft stop and forward stop).

### Example Operations for Data Intelligence Based Aircraft Parameter Adjustment in Association with Parabolic Flight

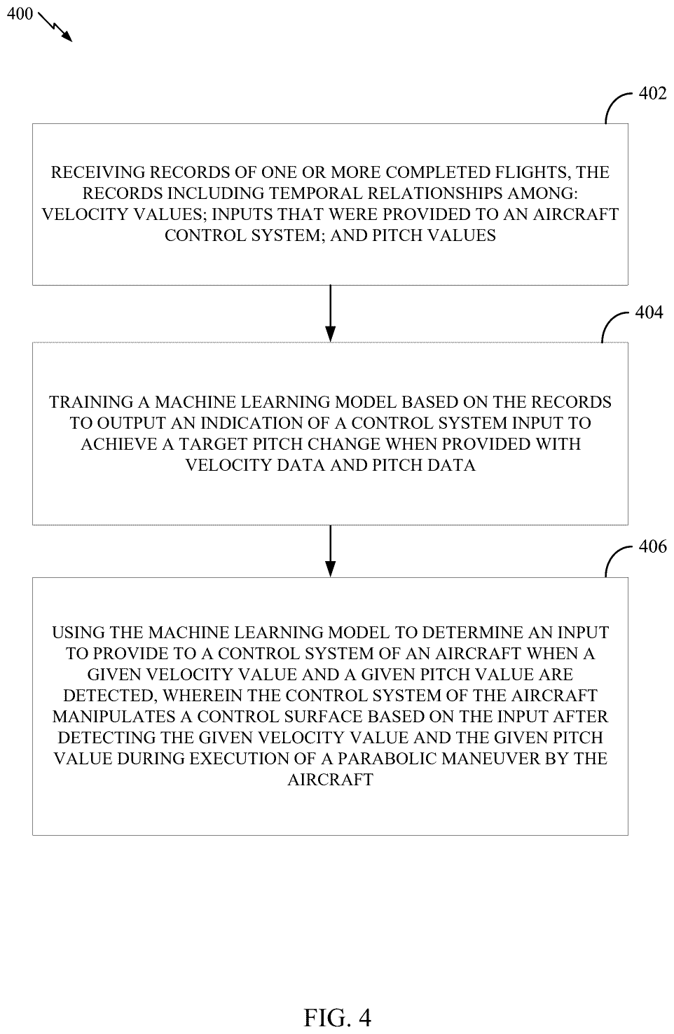

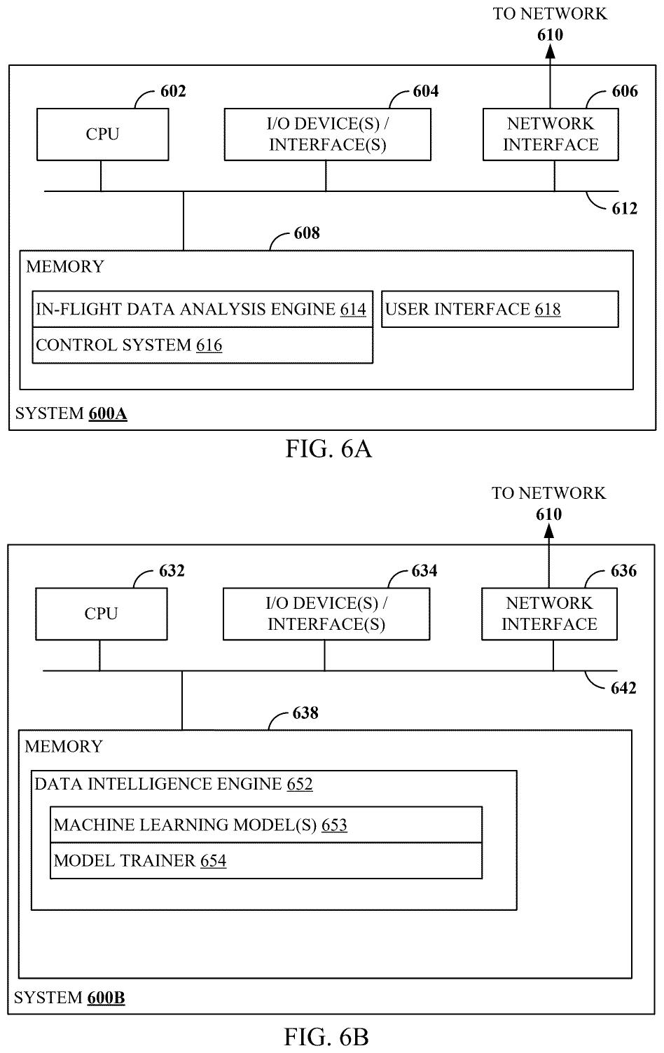

FIG. 4 depicts example operations 400 related to data intelligence based aircraft parameter adjustment in association with parabolic flight, according to certain embodiments. For example, operations 400 may be performed by one or more components described above with respect to FIGS. 1-3, system 600A or 600B of FIG. 6A or 6B (described below), and/or one or more other components and/or devices.

Operations 400 begin at step 402, with receiving records of one or more completed flights, the records including temporal relationships among: velocity values; inputs that were provided to an aircraft control system; and pitch values.

Operations 400 continue at step 404, with training a machine learning model based on the records to output an indication of a control system input to achieve a target pitch change when provided with velocity data and pitch data.

Operations 400 continue at step 406, with using the machine learning model to determine an input to provide to a control system of an aircraft when a given velocity value and a given pitch value are detected, wherein the control system of the aircraft manipulates a control surface based on the input after detecting the given velocity value and the given pitch value during execution of a parabolic maneuver by the aircraft.

In some embodiments, the records used to train the machine learning model further include one or more of: air speed; thrust; thrust lever position; gravitational force; jet engine core speed; aircraft pressure; cabin pressure; or latitude and longitude.

In certain embodiments, the training of the machine learning model comprises a supervised or unsupervised learning process by which the machine learning model learns correlations between control system inputs and resulting pitch changes in connection with particular velocity values.

In some embodiments, the records used to train the machine learning model were captured on the aircraft.

In certain embodiments, the using of the machine learning model to determine the input to provide to the control system of the aircraft comprises: providing one or more inputs to the machine learning model based on the given velocity value and the given pitch value; and receiving the input to provide to the control system of the aircraft as an output from the machine learning model in response to the one or more inputs.

In some embodiments, the aircraft control system achieves the target pitch change by the manipulating of the control surface.

In certain embodiments, the control surface comprises an elevator.

In some embodiments, the input is provided to the aircraft control system by manipulating a sidestick or a yoke

Notably, method 400 is just one example with a selection of example steps, but additional methods with more, fewer, and/or different steps are possible based on the disclosure herein.

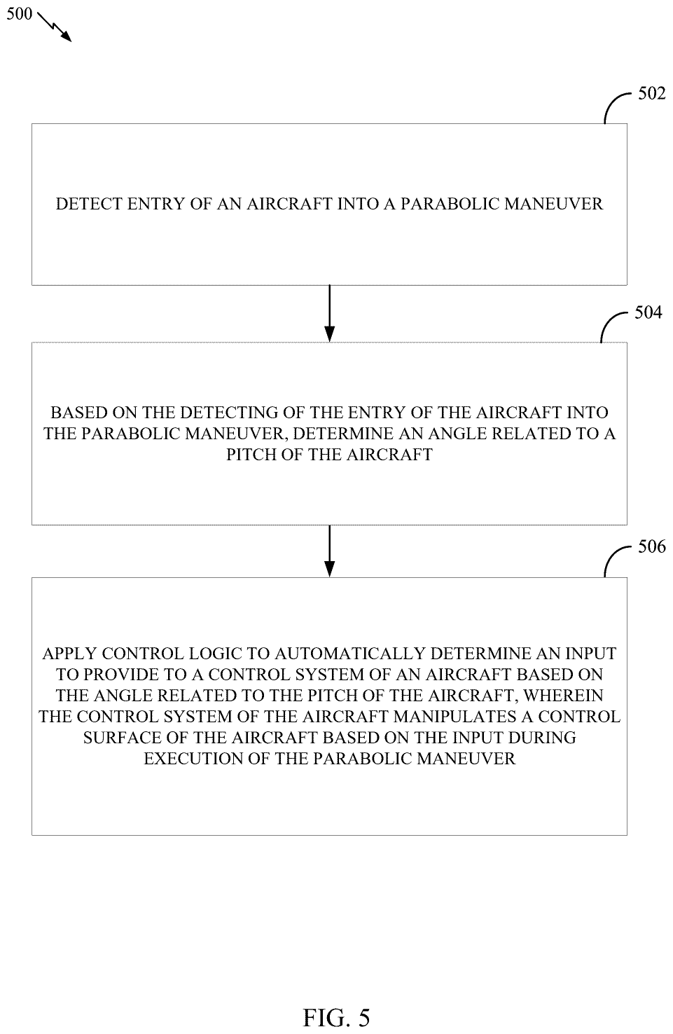

FIG. 5 depicts example operations 500 related to data intelligence based aircraft parameter adjustment in association with parabolic flight, according to certain embodiments. For example, operations 500 may be performed by one or more components described above with respect to FIGS. 1-3, system 600A or 600B of FIG. 6A or 6B (described below), and/or one or more other components and/or devices.

Operations 500 begin at step 502, with detecting entry of an aircraft into a parabolic maneuver.

Operations 500 continue at step 504, with, based on the detecting of the entry of the aircraft into the parabolic maneuver, determining an angle related to a pitch of the aircraft. For instance, the angle may comprise the pitch of the aircraft, a flight path angle of the aircraft, an angle of attack of the aircraft, or the like.

Operations 500 continue at step 506, with applying control logic to automatically determine an input to provide to a control system of the aircraft based on the angle related to the pitch of the aircraft, wherein the control system of the aircraft manipulates a control surface of the aircraft based on the input during execution of the parabolic maneuver.

In some aspects, the applying of the control logic to automatically determine the input to provide to the control system of the aircraft is further based on one more detected aircraft parameters comprising one or more of: velocity; air speed; thrust; thrust lever position; gravitational force; jet engine core speed; aircraft pressure; cabin pressure; or latitude and longitude.

In certain aspects, the control logic was generated based on a machine learning model trained through a supervised or unsupervised learning process by which the machine learning model learns correlations between control system inputs and resulting pitch-related value changes or gravity level changes in connection with one or more particular aircraft attributes.

In some embodiments, flight records used to train the machine learning model were captured on the aircraft.

Some aspects further comprise displaying an indication of the input via a user interface within the aircraft, wherein the control system of the aircraft manipulating the control surface of the aircraft based on the input occurs after the displaying of the indication of the input via the user interface and based on the input being provided to the control system.

In certain embodiments, the applying of the control logic comprises: providing one or more inputs to the machine learning model based on the angle related to the pitch of the aircraft; and receiving the input to provide to the control system of the aircraft as an output from the machine learning model in response to the one or more inputs. In other embodiments, the applying of the control logic comprises applying one or more rules, associations, or other types of logic determined based on the machine learning model or otherwise determined based on past flight records.

In some embodiments, the aircraft control system achieves a target change in a pitch-related angle or a target change in a gravity level by the manipulating of the control surface.

In certain embodiments, the control surface comprises an elevator.

In some embodiments, the input is provided to the aircraft control system by manipulating a sidestick or a yoke

Notably, method 500 is just one example with a selection of example steps, but additional methods with more, fewer, and/or different steps are possible based on the disclosure herein.

### Example Computing Systems

FIG. 6A illustrates an example system 600A with which embodiments of the present disclosure may be implemented. For example, system 600A may be configured to perform one or more of operations 400 of FIG. 4. In one example system 600A corresponds to one or more of aircraft computer system(s) 104 of FIG. 1.

System 600A includes a central processing unit (CPU) 602, one or more I/O device interfaces 604 that may allow for the connection of various I/O devices 614 (e.g., aircraft controls such as input device 330 of FIG. 3, aircraft sensors such as aircraft sensors 330 of FIG. 3, keyboards, displays, mouse devices, audio I/O devices, etc.) to the system 600A, network interface 606, a memory 608, and an interconnect 612. It is contemplated that one or more components of system 600A may be located remotely and accessed via a network 610. It is further contemplated that one or more components of system 600A may comprise physical components or software components.

CPU 602 may retrieve and execute programming instructions stored in the memory 608. Similarly, the CPU 602 may retrieve and store data residing in the memory 608. The interconnect 612 mat transmit programming instructions and data among the CPU 602, I/O device interface 604, network interface 606, and memory 608. CPU 602 is included to be representative of a single CPU, multiple CPUs, a single CPU having multiple processing cores, and other arrangements.

Additionally, the memory 608 is included to be representative of a random access memory, a disk drive, solid state drive, a collection of storage devices distributed across multiple storage systems, and/or the like. Although shown as a single unit, the memory 608 may be a combination of fixed and/or removable storage devices, such as fixed disc drives, removable memory cards or optical storage, network attached storage (NAS), or a storage area-network (SAN).

As shown, memory 608 includes an in-flight data analysis engine 614, a control system 616, and a user interface 618, which may correspond to inflight data analysis engine 310, control system 340, and user interface 320 of FIG. 3.

FIG. 6B illustrates another example system 600B with which embodiments of the present disclosure may be implemented. For example, system 600B may correspond to server 110 of FIG. 1, and may be configured to perform one or more of operations 400 of FIG. 4.

System 600B includes a CPU 632, one or more I/O device interfaces 634 that may allow for the connection of various I/O devices 634 (e.g., keyboards, displays, mouse devices, touch devices, audio I/O devices, etc.) to the system 600B, network interface 636, a memory 638, and an interconnect 642. It is contemplated that one or more components of system 600B may be located remotely and accessed via a network 610. It is further contemplated that one or more components of system 600B may comprise physical components or virtualized components.

CPU 632 may retrieve and execute programming instructions stored in the memory 638. Similarly, the CPU 632 may retrieve and store data residing in the memory 638. The interconnect 642 may transmit programming instructions and data among the CPU 632, I/O device interface 634, network interface 636, and memory 638. CPU 632 is included to be representative of a single CPU, multiple CPUs, a single CPU having multiple processing cores, and other arrangements.

Additionally, the memory 638 is included to be representative of a random access memory, a disk drive, solid state drive, a collection of storage devices distributed across multiple storage systems, and/or the like. Although shown as a single unit, the memory 638 may be a combination of fixed and/or removable storage devices, such as fixed disc drives, removable memory cards or optical storage, network attached storage (NAS), or a storage area-network (SAN).

As shown, memory 638 includes a data intelligence engine 652 comprising machine learning model(s) 653 and model trainer 654, which may correspond to data intelligence engine 112, machine learning model(s) 114, and model trainer 202 of FIGS. 1 and 2.

It is noted that systems 600A and 600B are included as examples, and certain functionality described with respect to systems 600A and/or 600B and/or otherwise described herein may be implemented via more or fewer devices and/or components.

### Example Clauses

Implementation examples are described in the following numbered clauses:

Clause 1: A method for data intelligence based aircraft parameter adjustment in association with parabolic flight, comprising: receiving records of one or more completed flights, the records including temporal relationships among: velocity values; inputs that were provided to an aircraft control system; and pitch values; training a machine learning model based on the records to output an indication of a control system input to achieve a target pitch change when provided with velocity data and pitch data; and using the machine learning model to determine an input to provide to a control system of an aircraft when a given velocity value and a given pitch value are detected, wherein the control system of the aircraft manipulates a control surface based on the input after detecting the given velocity value and the given pitch value during execution of a parabolic maneuver by the aircraft.

Clause 2: The method of Clause 1, wherein the records used to train the machine learning model further include one or more of: air speed; thrust; thrust lever position; gravitational force; jet engine core speed; aircraft pressure; cabin pressure; or latitude and longitude.

Clause 3: The method of any one of Clause 1-2, wherein the training of the machine learning model comprises a supervised or unsupervised learning process by which the machine learning model learns correlations between control system inputs and resulting pitch changes in connection with particular velocity values.

Clause 4: The method of any one of Clause 1-3, wherein the records used to train the machine learning model were captured on the aircraft.

Clause 5: The method of any one of Clause 1-4, wherein the using of the machine learning model to determine the input to provide to the control system of the aircraft comprises: providing one or more inputs to the machine learning model based on the given velocity value and the given pitch value; and receiving the input to provide to the control system of the aircraft as an output from the machine learning model in response to the one or more inputs.

Clause 6: The method of any one of Clause 1-5, wherein the aircraft control system achieves the target pitch change by the manipulating of the control surface.

Clause 7: The method of Clause 6, wherein the control surface comprises an elevator.

Clause 8: The method of any one of Clause 1-7, wherein the input is provided to the aircraft control system by manipulating a sidestick or a yoke.

Clause 9: A system for data intelligence based aircraft parameter adjustment in association with parabolic flight, comprising: one or more processors; and a memory comprising instructions that, when executed by the one or more processors, cause the system to: receive records of one or more completed flights, the records including temporal relationships among: velocity values; inputs that were provided to an aircraft control system; and pitch values; train a machine learning model based on the records to output an indication of a control system input to achieve a target pitch change when provided with velocity data and pitch data; and use the machine learning model to determine an input to provide to a control system of an aircraft when a given velocity value and a given pitch value are detected, wherein the control system of the aircraft manipulates a control surface based on the input after detecting the given velocity value and the given pitch value during execution of a parabolic maneuver by the aircraft.

Clause 10: The system of Clause 9, wherein the records used to train the machine learning model further include one or more of: air speed; thrust; thrust lever position; gravitational force; jet engine core speed; aircraft pressure; cabin pressure; or latitude and longitude.

Clause 11: The system of any one of Clause 9-10, wherein the training of the machine learning model comprises a supervised or unsupervised learning process by which the machine learning model learns correlations between control system inputs and resulting pitch changes in connection with particular velocity values.

Clause 12: The method of any one of Clause 9-11, wherein the records used to train the machine learning model were captured on the aircraft.

Clause 13: The system of any one of Clause 9-12, wherein the using of the machine learning model to determine the input to provide to the control system of the aircraft comprises: providing one or more inputs to the machine learning model based on the given velocity value and the given pitch value; and receiving the input to provide to the control system of the aircraft as an output from the machine learning model in response to the one or more inputs.

Clause 14: The system of any one of Clause 9-13, wherein the aircraft control system achieves the target pitch change by the manipulating of the control surface.

Clause 15: The system of Clause 14, wherein the control surface comprises an elevator.

Clause 16: The system of any one of Clause 9-15, wherein the input is provided to the aircraft control system by manipulating a sidestick or a yoke.

Clause 17: A non-transitory computer readable medium comprising instructions that, when executed by one or more processors of a computing system, cause the computing system to: receive records of one or more completed flights, the records including temporal relationships among: velocity values; inputs that were provided to an aircraft control system; and pitch values; train a machine learning model based on the records to output an indication of a control system input to achieve a target pitch change when provided with velocity data and pitch data; and use the machine learning model to determine an input to provide to a control system of an aircraft when a given velocity value and a given pitch value are detected, wherein the control system of the aircraft manipulates a control surface based on the input after detecting the given velocity value and the given pitch value during execution of a parabolic maneuver by the aircraft.

Clause 18: The non-transitory computer readable medium of Clause 17, wherein the records used to train the machine learning model further include one or more of: air speed; thrust; thrust lever position; gravitational force; jet engine core speed; aircraft pressure; cabin pressure; or latitude and longitude.

Clause 19: The non-transitory computer readable medium of any one of Clause 17-18, wherein the training of the machine learning model comprises a supervised or unsupervised learning process by which the machine learning model learns correlations between control system inputs and resulting pitch changes in connection with particular velocity values.

Clause 20: The non-transitory computer readable medium of any one of Clause 17-19, wherein the records used to train the machine learning model were captured on the aircraft.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for data intelligence based aircraft parameter adjustment in association with parabolic flight, comprising:
receiving records of one or more completed flights, the records including temporal relationships among: velocity values; inputs that were provided to an aircraft control system; and pitch values;
training a machine learning model based on the records to output an indication of a control system input to achieve a target pitch change when provided with velocity data and pitch data; and
using the machine learning model to determine an input to provide to a control system of an aircraft when a given velocity value and a given pitch value are detected, wherein the control system of the aircraft manipulates a control surface based on the input after detecting the given velocity value and the given pitch value during execution of a parabolic maneuver by the aircraft.

2. The method of claim 1, wherein the records used to train the machine learning model further include one or more of:
air speed;
thrust;
thrust lever position;
gravitational force;
jet engine core speed;
aircraft pressure;
cabin pressure; or
latitude and longitude.

3. The method of claim 1, wherein the training of the machine learning model comprises a supervised or unsupervised learning process by which the machine learning model learns correlations between control system inputs and resulting pitch changes in connection with particular velocity values.

4. The method of claim 1, wherein the records used to train the machine learning model were captured on the aircraft.

5. The method of claim 1, wherein the using of the machine learning model to determine the input to provide to the control system of the aircraft comprises:
providing one or more inputs to the machine learning model based on the given velocity value and the given pitch value; and
receiving the input to provide to the control system of the aircraft as an output from the machine learning model in response to the one or more inputs.

6. The method of claim 1, wherein the aircraft control system achieves the target pitch change by the manipulating of the control surface.

7. The method of claim 6, wherein the control surface comprises an elevator.

8. The method of claim 1, wherein the input is provided to the aircraft control system by manipulating a sidestick or a yoke.

9. A system for data intelligence based aircraft parameter adjustment in association with parabolic flight, comprising:
one or more processors; and
a memory comprising instructions that, when executed by the one or more processors, cause the system to:
receive records of one or more completed flights, the records including temporal relationships among: velocity values; inputs that were provided to an aircraft control system; and pitch values;
train a machine learning model based on the records to output an indication of a control system input to achieve a target pitch change when provided with velocity data and pitch data; and
use the machine learning model to determine an input to provide to a control system of an aircraft when a given velocity value and a given pitch value are detected, wherein the control system of the aircraft manipulates a control surface based on the input after detecting the given velocity value and the given pitch value during execution of a parabolic maneuver by the aircraft.

10. The system of claim 9, wherein the records used to train the machine learning model further include one or more of:
air speed;
thrust;
thrust lever position;
gravitational force;
jet engine core speed;
aircraft pressure;
cabin pressure; or
latitude and longitude.

11. The system of claim 9, wherein the training of the machine learning model comprises a supervised or unsupervised learning process by which the machine learning model learns correlations between control system inputs and resulting pitch changes in connection with particular velocity values.

12. The method of claim 1, wherein the records used to train the machine learning model were captured on the aircraft.

13. The system of claim 9, wherein the using of the machine learning model to determine the input to provide to the control system of the aircraft comprises:
providing one or more inputs to the machine learning model based on the given velocity value and the given pitch value; and
receiving the input to provide to the control system of the aircraft as an output from the machine learning model in response to the one or more inputs.

14. The system of claim 9, wherein the aircraft control system achieves the target pitch change by the manipulating of the control surface.

15. The system of claim 14, wherein the control surface comprises an elevator.

16. The system of claim 9, wherein the input is provided to the aircraft control system by manipulating a sidestick or a yoke.

17. A system for data intelligence based aircraft parameter adjustment in association with parabolic flight, comprising:
one or more processors; and
a memory comprising instructions that, when executed by the one or more processors, cause the system to:
detect entry of an aircraft into a parabolic maneuver;
based on the detecting of the entry of the aircraft into the parabolic maneuver, determine an angle related to a pitch of the aircraft; and
apply control logic to automatically determine an input to provide to a control system of the aircraft based on the angle related to the pitch of the aircraft, wherein the control system of the aircraft manipulates a control surface of the aircraft based on the input during execution of the parabolic maneuver.

18. The system of claim 17, wherein the applying of the control logic to automatically determine the input to provide to the control system of the aircraft is further based on one more detected aircraft parameters comprising one or more of:
velocity;
air speed;
thrust;
thrust lever position;
gravitational force;
jet engine core speed;
aircraft pressure;
cabin pressure; or
latitude and longitude.

19. The system of claim 17, wherein the control logic was generated based on a machine learning model trained through a supervised or unsupervised learning process by which the machine learning model learns correlations between control system inputs and resulting pitch-related value changes or gravity level changes in connection with one or more particular aircraft attributes.

20. The system of claim 17, wherein the instructions, when executed by the one or more processors, further cause the system to display an indication of the input via a user interface within the aircraft, wherein the control system of the aircraft manipulating the control surface of the aircraft based on the input occurs after the displaying of the indication of the input via the user interface and based on the input being provided to the control system.
